(19) United States
(12) Patent Application Publication
(10) Pub. No.: US 2022/0400628 A1
(43) Pub. Date: Dec. 22, 2022

(54) Environmental Control System Optimized for Small Scale Mushroom Cultivation

(71) Applicant: Nicholas Scott Reimnitz, South San Francisco, CA (US)

(72) Inventor: Nicholas Scott Reimnitz, South San Francisco, CA (US)

(21) Appl. No.: 17/352,256

(22) Filed: Jun. 19, 2021

(51) Int. Cl. A01G 18/64; G08C 17/02

(52) U.S. Cl. CPC A01G 18/64; G08C 17/02

(57) ABSTRACT

The present invention relates to an advancement in a system primarily designed to he used for the cultivation of saprophytic mushrooms. It provides the basic necessities of mushroom growth, including fresh air exchange, humidity, light, and warmth. It also monitors environmental variables, including at least humidity and temperature, and other variables related to the system, such as water reservoir level. It transmits this information wirelessly via either Bluetooth or WIFI antennas, to an external system for recording and/or monitoring. The information from the sensors may also he used to form a closed feedback loop to control output of the systems controlling the environmental conditions.

### BACKGROUND

### Field of the Invention

The instant invention relates generally to and more specifically it relates to a system controlling a closed environment, including sensors and actuators which may monitor and maintain the environment, with the intention of creating an optimal environment for the growth of saprophytic mushrooms.

### Description of the Related Art

Mushroom cultivation is currently a process which is most commonly undertaken by professional fanning operations, which produce a relatively large amount of mushrooms. Although they may use control systems similar to what is described, (to my knowledge) there does not yet exist a consumer product which enables the functionality on a smaller level. Additionally, this system provides remote data monitoring and control of the functional systems via an external method, such as an app on a smartphone.

This invention relates to an arrangement for cultivating mushrooms and the like from mycelium in small quantities, and more particularly to equipment for raising mushrooms under conditions markedly different from the environment long considered mandatory for successful growth by commercial mushroom growers, by using a closed and controlled environment to create conditions amicable to growth.

Prior to the present invention, mushrooms have been cultivated with success primarily in underground caves or mines, or in large, expensive mushroom growing houses wherein critical environmental characteristics can be carefully controlled to suit the notoriously temperamental and difficult crop. Conditions such as light, temperature, humidity, ventilation and the like are carefully maintained by experienced professional growers at different critical balances during successive portions of the mushroom growing cycle. Attempts to fruit mushrooms in small quantities outside of laboratories, on the other hand, generally require a farmer to build expensive infrastructure, and often results in contamination or other failure.

By looking at prior art, multiple types of inventions have been seen in similar regards. For instance, a U.S. Pat. No. 1,833,089 discloses cultivating mushroom spawn on a substrate comprising sawdust and bran which is heat-sterilised and cooled before addition of the spawn.

U.S. Pat. No. 4,127,965 discloses cultivating Shiitake and other mushrooms on a substrate comprising cellulosic material, preferably in tree log form, and nutrients.

Ando, Proc. Ninth Int. Sci. Congress on the Cultivation of Edible Fungi, Tokyo 1974, pages 415-421, discloses using a variety of media for growing Shiitake mushrooms. Artificial media gave fruit-body formation in about 40 days, and sawdust media (of Castanopsis cuspidata or Fagus crenata) in about 70 days.

EP-A-0107911 describes swelling cereal grain in water, sterilizing the grain, inoculating the sterile grain with a mushroom culture, and incubating the inoculated grain.

The present invention overcomes the disadvantages of the prior art. It has to be noted that the current invention proposes an advancement where it provides a new approach of a system primarily designed to be used for the cultivation of saprophytic mushrooms. This invention pertains to fungus cultivation. More specifically, it is equipment for the small-scale or consumer-level production of mushrooms. It involves sensing and control technologies which are capable of maintaining desired environmental conditions within a confined space. A primary object of the present invention is to provide an enhanced approach of a system containing a closed environment, including sensors and controllers which may monitor and maintain the environment, with the intention of creating an optimal environment for the growth of saprophytic mushrooms.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and. is not intended. to be a full description. A full appreciation of the various aspects of the invention can be gained by taking the entire specification, claims, drawings, and abstract as a whole.

The present invention seeks to improve upon prior mushroom growth technique and provide an enhanced approach toward better mushroom growth technique.

Another object of the present invention is to provide a system containing a closed environment, including sensors and controllers which may monitor and maintain the environment, with the intention of creating an optimal environment for the growth of saprophytic mushrooms.

It is a further objective of the present invention to provide an enclosed space where the environment is enclosed to make it difficult for contaminants and insects to enter into the space.

it is also an object of the invention to provide fresh air where a fan or a plurality of fans provide fresh filtered air into the enclosure, ensuring that oxygen is available to the mushrooms as they grow, and that carbon dioxide is removed. Furthermore, this also creates positive pressure inside the enclosure, further increasing the difficulty of foreign objects to enter.

It is further the objective of the invention to provide an assembly which includes a humidity sensor, as well as a mister that is capable of increasing humidity levels.

It is also the objective of the invention to provide an assembly where the system will enable a user to set a desired humidity level, which will be maintained using closed loop control between the sensor and mister.

It is further the objective of invention to provide a system which enables the use of lights, which may be programmed. Light is necessary for proper mushroom fruit body development, and the optional light control will enable the system to be placed in an environment devoid of light (such as a. closet).

It is also the objective of invention to allow light cycles to be programmed; e.g., 12 hours on, 12 hours off.

It is also the objective of the invention to provide a system which enables the addition of heat, to increase the temperature of the controlled space to 70-80 degrees Fahrenheit.

Thus, it is the objective to provide a new and improved form of an advancement in a mushroom growth method. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1 discloses front view of device as per preferred embodiments of the invention.

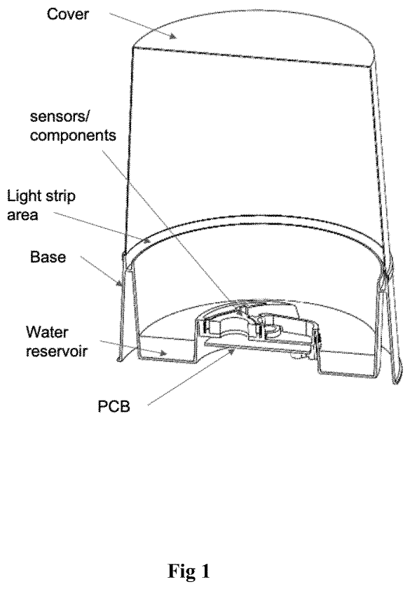

FIG. 2 discloses the mushroom and mushroom substrate block assembly as per preferred embodiments of the invention.

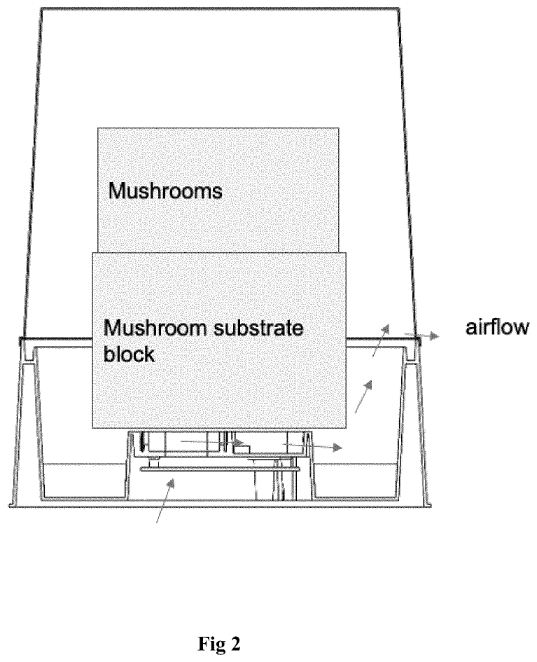

FIG. 3 discloses alternative implementation where the sensors can be used to control any space which is properly installed as per preferred embodiments of the invention.

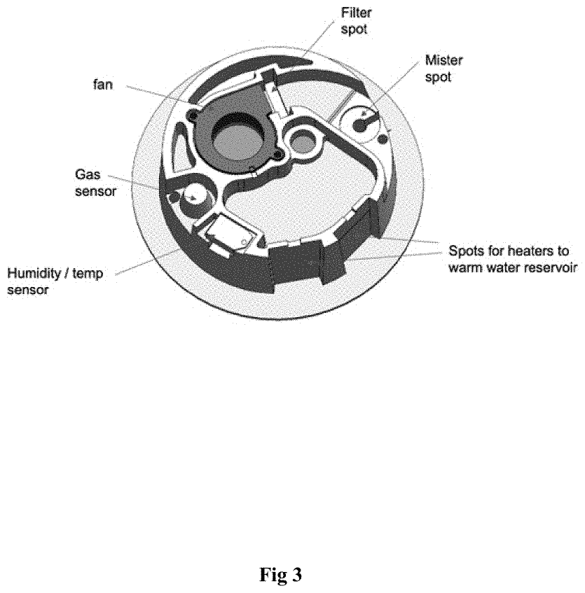

FIG. 4 discloses another view of PCB assembly as per preferred embodiments of the invention.

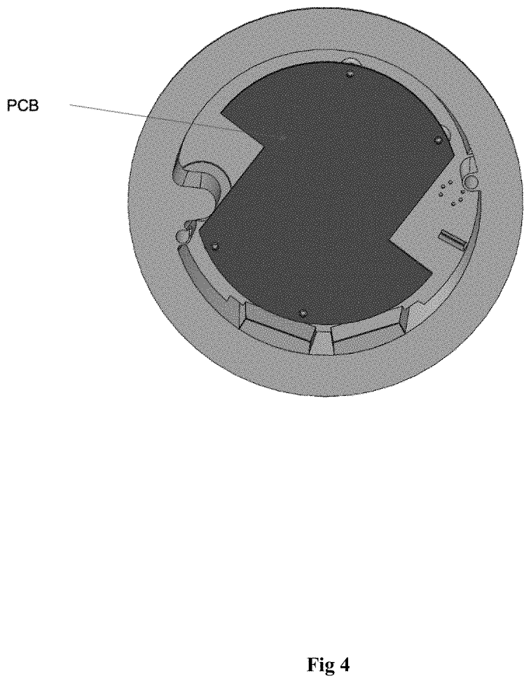

FIG. 5 discloses complete view of assembly as per preferred embodiments of the invention.

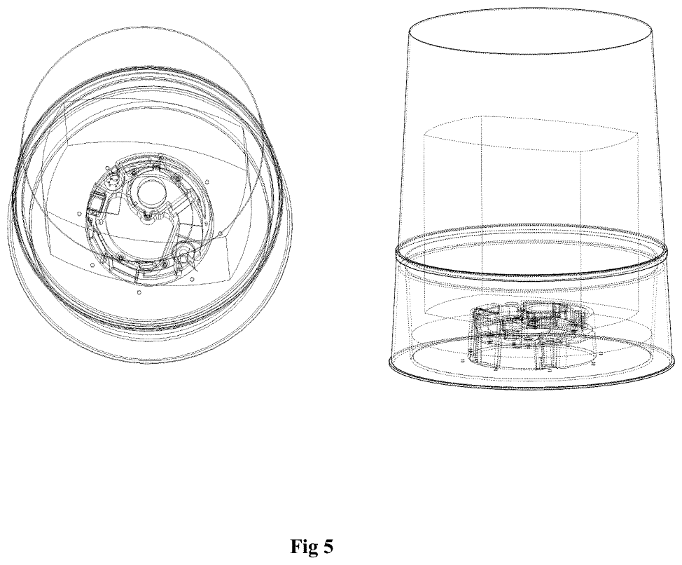

FIG. 6 discloses top view of assembly as per preferred embodiments of the invention.

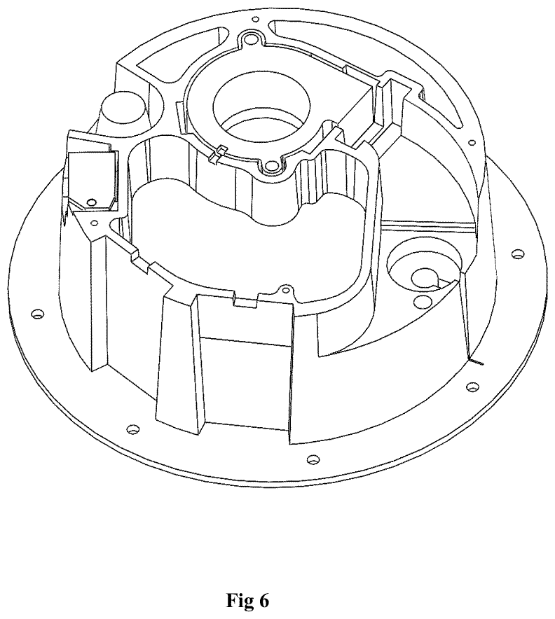

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The cultivation of mushrooms has a venerable history. While mushrooms grow readily in the natural state where they find a supportive environment, efforts to cultivate mushrooms require great care in order to obtain an economic crop. In producing cultivated mushrooms, a substrate must be provided which enables the growth of the desired mushroom, and sterile technique must be utilized in the creation of substrates to discourage the invasion of undesirable bacteria and fungi. During fruiting, mushrooms are particularly susceptible to variations in their environment and their growth can be substantially or completely inhibited when the environment does not provide the necessary degree of moisture, temperature, light, and aeration.

Since the edible mushroom is an excellent source of food values, there is an increasing interest in enhancing the ability to grow mushrooms in an economical manner. Furthermore the mushroom can be grown on waste materials, and thus mushroom cultivation provides a method for turning waste materials into human food. Finally, the substrate or compost employed after mushroom growth is exhausted, can be employed for mulching or composting crops.

In developing new techniques for growing mushrooms and in working with new species or phenotypes, it is desirable to provide an enhanced scientific approach on a small scale toward developing optimally favorable conditions for higher-scale fanning efforts.

The current invention presents an assembly which provides a controllable environment enabling creation of favorable conditions for the growth of mushrooms.

The assembly as per its preferred embodiments presents a filter, which is to keep the space free from contaminants and pests, while providing enough fresh air to enable mushroom growth.

The light, especially blue and green light, is required for ideal mushroom fruit-body development. The system as per its further embodiments will include a lighting system to ensure that the mushrooms receive sufficient light for growth, even if the system is installed in a location devoid of light, such as a closet. Lighting options include RGB lights, fluorescent light(s), or perhaps a different option.

The Temperature is also the required embodiment of invention. As understood, mushrooms grow faster when the temperature is kept around 70-80 degrees Fahrenheit. The goal of the system is to provide ideal conditions, so an effort is ongoing to determine the best option for providing some amount of heat, given the power budget available. This can include but not limited to a resistive heating element, such as nichrome wire, in the inlet air stream, or a submersible heating element into the water reservoir, to increase the temperature of the reservoir.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

I: A system designed to be used for the cultivation of saprophytic mushrooms comprising:
basic necessities of mushroom growth, including fresh air exchange;
humidity; optionally light; and., optionally warmth.

II: A system to monitor environmental variables, including but not limited to: humidity and temperature, and other variables related to the system, such as water reservoir level.

III: A system to transmit this information wirelessly via either Bluetooth or WIFI antennas, to an external system for recording and/or monitoring. The information from the sensors may also be used to form a closed feedback loop to control output of the systems controlling the environmental conditions.
